(19) United States
(12) Patent Application Publication
(10) Pub. No.: US 2017/0139777 A1
(43) Pub. Date: May 18, 2017

(54) SYSTEMS AND METHODS FOR VIRTUALIZATION BASED SECURE DEVICE RECOVERY

(71) Applicant: PCMS Holdings, Inc., Wilmington, DE (US)

(72) Inventor: Christian M. Gehrmann, Lund (SE)

(73) Assignee: PCMS Holdings, Inc., Wilmington, DE (US)

(21) Appl. No.: 15/325,545

(22) PCT Filed: Jul. 10, 2015
(86) PCT No.: PCT/US2015/039965

§ 371 Date: Jan. 11, 2017

Related U.S. Application Data
(60) Provisional application No. 62/023,774, filed on Jul. 11, 2014.

(51) Int. Cl. G06F 11/14; G06F 9/455; H04L 29/06; G06F 21/56; G06F 21/57

(52) U.S. Cl. CPC G06F 11/1433; G06F 21/568; G06F 21/575; H04L 63/1458; G06F 9/45558; G06F 2009/45587; G06F 2201/815

(57) ABSTRACT

Systems, methods, and/or techniques for performing device recovery using a device management agent (DMAG) on a device may be provided. The DMAG may be in secure execution environment that may be protected by a hypervisor and/or may include or have a full network stack (e.g., via a tiny operating system associated therewith). The DMAG or other entity on the device may receive control of the device and/or may determine or detect whether an application and/or an operating system on the device may not be in a normal service. The DMAG or other entity may initiate a secure session with a DMS based on the application and/or operating system not being in the normal service such that the DMS may determine whether the device may have a potential software problem. The DMAG or other entity may set up or establish a recovery and/or upgrade session based on the device having the potential software problem (e.g., using the secure session) and/or may receive a software image to do a re-flash of the operating system and/or the application. The DMAG or other entity may send a re-bot request command such that the device may be re-booted (e.g., to get back into the normal service).

### CROSS-REFERENCE TO RELATED APPLICATIONS

This application claims the benefit of the U.S. Provisional Application No. 62/023,774, filed Jul. 11, 2014, which is hereby incorporated by reference herein.

### BACKGROUND

Typically, current network embedded devices may be upgraded through a device management agent that may run as a separate process on an operating system (OS). In such an example, an attack on a kernel thereof such as the main OS kernel or a critical software failure in the OS may destroy the functionality of the complete system and/or the system may not be robust for security against software attacks. Additionally, systems such as a computer system like a personal computer (PC) may be upgraded through a device management agent that may run in a separate virtual machine. The virtual machine may be protected by a hypervisor. Unfortunately, such systems may not be robust for an embedded device that may be threatened by active software attacks.

### SUMMARY

Systems, methods, and/or techniques for performing device recovery using a device management agent (DMAG) on a device may be provided. The DMAG may be in secure execution environment that may be protected by a hypervisor and/or may use or include a tiny operating system that may include or have a full network stack. The DMAG or other entity on the device may receive control of the device and/or may determine or detect whether an application and/or an operating system on the device may not be in a normal service (e.g., upon or after receiving such control). The DMAG or other entity may initiate a secure session with a DMS based on the application and/or operating system not being in the normal service such that the DMS may determine whether the device may have a potential software problem. In examples, such a software problem may be that an application system may have been infected by malware that make the application stop functioning or not behaving as expected, may be that a function may stop working due to a bug after a software upgrade to the application system, and/or the like. The DMAG or other entity may set up or establish a recovery and/or upgrade session based on the device having the potential software problem (e.g., using the secure session) and/or may receive a software image to do a re-flash of the operating system and/or the application. A re-flash may include a reinstallation of the application system (e.g., including the operating system) and/or an entire or whole platform software into a state that may be known to function without bugs or with malware. In one example, the DMAG or other entity may send a re-boot request command such that the device may be re-booted (e.g., to get back into the normal service). The re-boot request command may be sent and/or the device re-booted after the re-flash (e.g., when the whole application system including the application system operating system may have been re-installed). Additionally, in examples, the application (e.g., not the whole application system) may be re-flashed and/or re-installed as described herein. In such an example, a re-boot may not be performed and/or may not occur.

In an example, an integrity of one or more of a hypervisor on the device, a tiny OS on the device, and/or the DMAG may be verified or checked during re-boot (e.g., in response to the re-boot command request and re-boot occurring). The integrity may be checked using a secure boot process and/or secure boot code. Further, a set of diagnostic commands may be received from the DMS to determine whether the application and/or operating system may be in the normal service (e.g., such that the DMAG may determine whether the device may be in the normal service). Further, in examples, a failure notification may be provided (e.g., sent or received) that may indicate a fault behavior including that the application and/or operating system may not be in the normal service. The failure notification may be registered and/or stored using the DMS in one example. Additionally, according to examples, the control of the device (e.g., execution control thereof) may be received via a handover by the device and/or the hypervisor. The handover may occur from a WatchDog timer reset such that the hypervisor and/or the device may use the WatchDog timer to force the control to the DMAG. Additionally, the application and/or the operating system on the device not being be in the normal service may be determined or detected based on the handover occurring from the WatchDog timer reset. In an example, an external network request such as an external network connection request may not be accepted or may be denied (e.g., by the DMAG) and/or an external network request may be initiated (e.g., by the DMAG) such that the request may be directed to a limited number of trusted external management entities such as the DMS.

The Summary is provided to introduce a selection of concepts in a simplified form that are further described below in the Detailed Description. This Summary is not intended to identify key features or essential features of the claimed subject matter, not is it intended to be used to limit the scope of the claimed subject matter. Furthermore, the claimed subject matter is not limited to the examples herein that may solve one or more disadvantages noted in any part of this disclosure.

### BRIEF DESCRIPTION OF THE DRAWINGS

A more detailed understanding of the embodiments disclosed herein may be had from the following description, given by way of example in conjunction with the accompanying drawings.

FIG. 1 illustrates an example of an embedded device that include a device management agent that may run as a separate process on an operating system (OS).

FIG. 2 illustrates an example of a system that may include a device management agent that may run in a virtual machine that may be protected by a hypervisor.

FIG. 3 illustrates an example network architecture or scenario.

FIG. 4 illustrates an example of a device management life cycle or method that may be used in one or more of the examples described herein.

FIG. 5 illustrates an example of a system architecture that may be used in one or more of the examples described herein.

FIG. 6 illustrates an example of performing device recovery for one or more of the examples described herein.

FIG. 7 illustrates a flow diagram of an example method for performing device recovery for one or more of the examples described herein.

FIG. 8 illustrates an example of a system architecture for a multicore system that may be used in one or more of the examples described herein.

FIGS. 9-10 illustrate examples in which the systems and/or methods herein for performing device recovery may be implemented and/or used.

FIG. 11A depicts a diagram of an example communications system in which one or more disclosed examples may be implemented and/or may be used with one or more of the examples described herein.

FIG. 11B depicts a system diagram of an example wireless transmit/receive unit (WTRU) that may be used within the communications system illustrated in FIG. 11A.

FIG. 11C depicts a system diagram of an example radio access network and an example core network that may be used within the communications system illustrated in FIG. 11A.

FIG. 11D depicts a system diagram of another example radio access network and an example core network that may be used within the communications system illustrated in FIG. 11A.

FIG. 11E depicts a system diagram of another example radio access network and an example core network that may be used within the communications system illustrated in FIG. 11A.

### DETAILED DESCRIPTION

A detailed description of illustrative embodiments may now be described with reference to the various Figures. Although this description provides a detailed example of possible implementations, it should be noted that the details are intended to be exemplary and in no way limit the scope of the examples described herein.

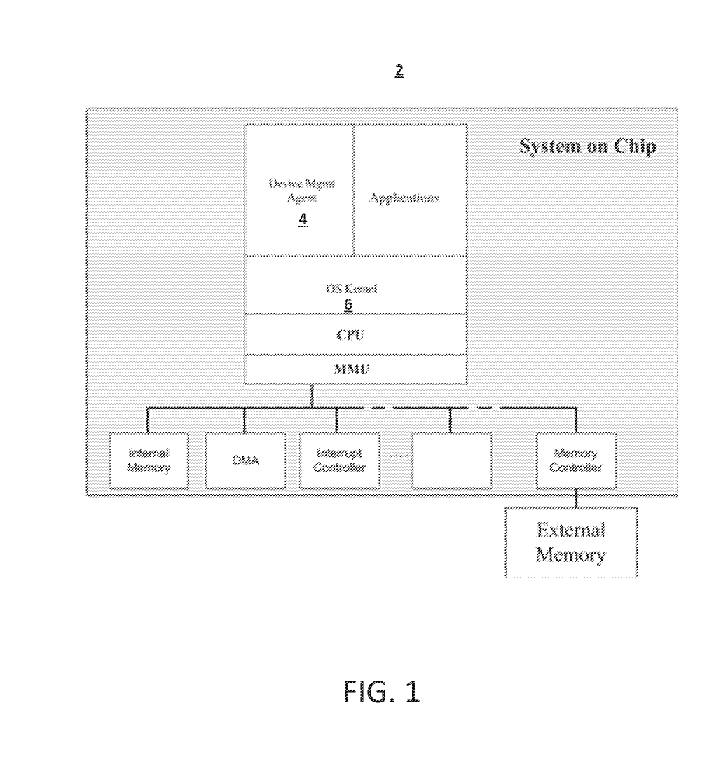

As described herein, typically, current network embedded devices may be upgraded through a device management agent running as a separate process on an ordinary OS. FIG. 1 illustrates an example of such current network embedded device 2 that may include a device management agent 4 running as a separate process on an OS (e.g., in a system on chip or (SoC)). In such an example, an attack on the main OS kernel 6 or a critical software failure in the main OS may destroy the functionality of the system (e.g., of the device 2). Additionally, according to an example, it may be hard to guarantee the robustness and security of a large OS kernel as shown. As such, it may be desirable to keep the security critical software base at a minimum. For example, a critical failure or attack on the OS kernel may invoke a manual reset of the device, which may be costly and time consuming.

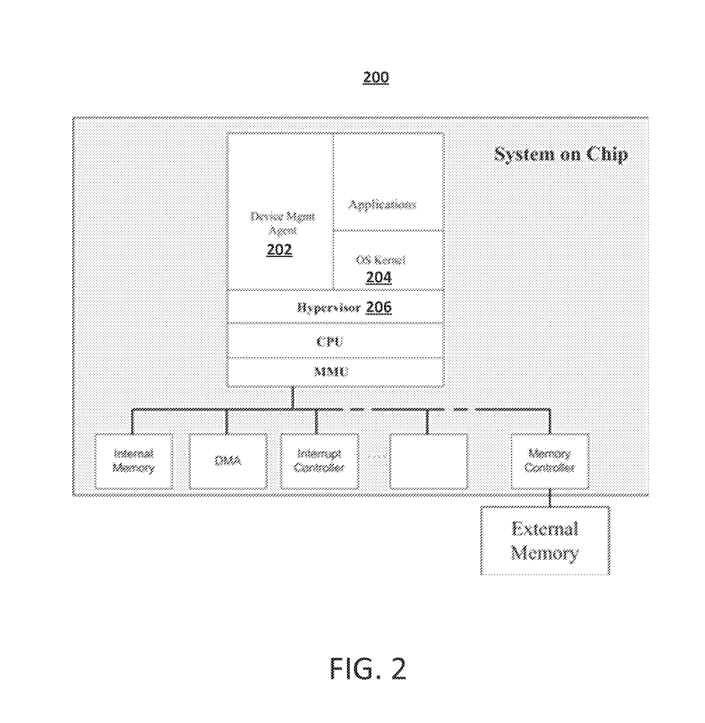

In examples, there may further be systems such as the system shown in FIG. 2. As shown in FIG. 2, a system 200 may include a device management agent 202. The device management agent 202 may run in a separate virtual machine protected by a hypervisor 206. Such system is much more robust in the sense that an attack on a main OS 204 or critical software failure on the main OS may not affect the device management function. However, the system may not be robust for an embedded device. For example, to be robust in a scenario of an embedded device being threatened by active software attacks, one or more of the following may be beneficial and/or may not be provided by such a system. The software integrity of the hypervisor and the device management agent may not be guaranteed at boot time and/or during run time. In such examples, unfortunately, device management operations may not be carried out by a central, more computational powerful, device management system and/or a hypervisor protected device management agent may not be configured to accept control commands from such a central unit. Additionally, such a system (e.g., as shown in FIG. 2) may not be robust against software attacks on the main OS running in the system and may not have a “self-healing” mechanism to recover from critical software failures on the main OS.

As such, systems and/or method may be provided herein that may improve robustness of such current systems and/or embedded devices. For example, the system and/or methods described herein may include a network embedded device management system that may be robust against fatal software failures in a main OS as well as against active attacks on that part of the system. Additionally, the system and/or methods may improve the software integrity of the hypervisor and the device management agent at boot time and/or during run time. Device management operations may be carried out by a central, more computational powerful, device management system and/or a hypervisor protected device management agent may be configured to accept control commands from such a central unit. The system may be robust against software attacks on the main OS running in the system and may have a “self-healing” mechanism to recover from critical software failures on the main OS.

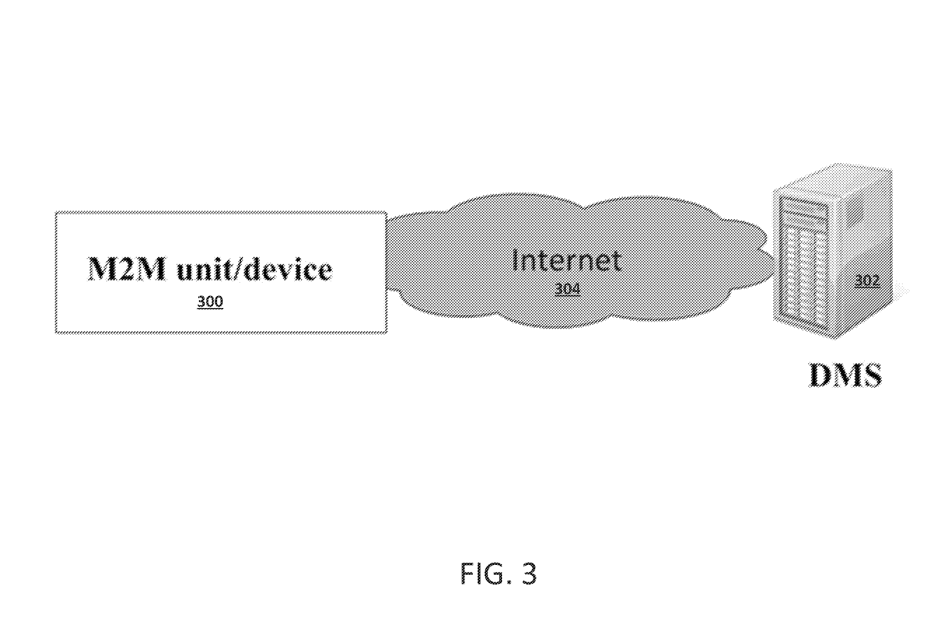

FIG. 3 illustrate an example general network scenario or architecture (e.g., that may improve robustness and/or may provide a centralized system and/or hypervisor to improve such robustness and/or software integrity). As shown in FIG. 3, a device such as a machine to machine (M2M) device 300 (e.g., a network embedded device or system) may be in communication with a device management back-end system 302 via a network such as the Internet 304. According to examples, network embedded systems or devices such as M2M units (e.g., 300) may be starting to become important in different kind of systems with high security/safety demands. As such, it may be desirable to improve or guarantee the robust operation of such systems. In particular, there may be a threat against the M2M units from a network based attacks and/or software malware. A security and/or safety critical unit may stop function from a failure, attacks, and/or malware. According to an example (e.g., if a security and/or safety critical unit stops functioning due to a software failure or due to an attack), consequences may be provided that may be severe and in some circumstances may even threaten human lives.

From a security architecture perspective, a device or device platform may be an important part of an M2M security solution. For example, to design solutions that may work in real and practical use case scenarios, a life-cycle management perspective for a device platform may be used and/or considered.

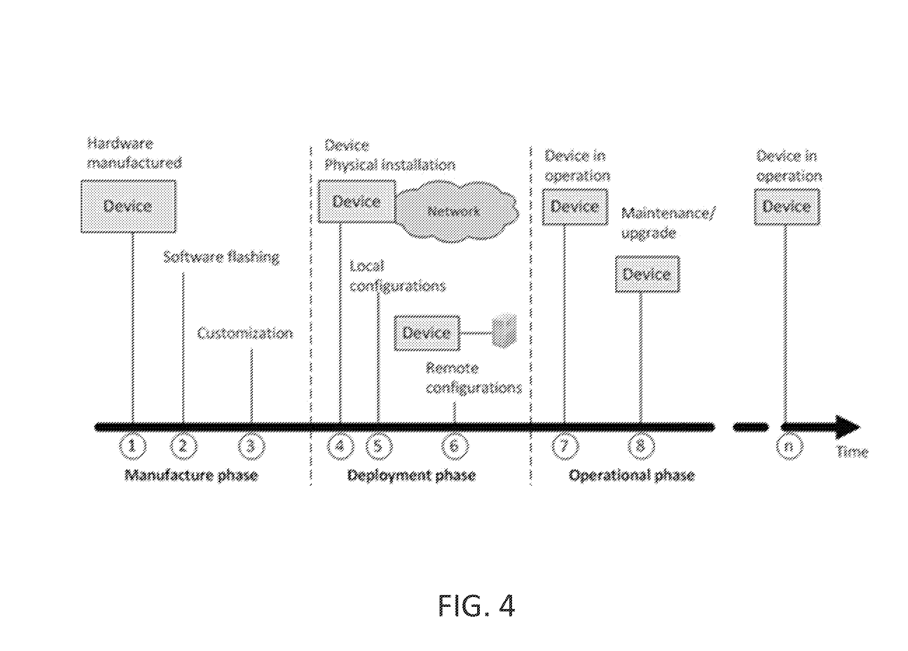

FIG. 4 illustrates an example of a device life cycle perspective that may be used and/or considered for one or more examples herein. As shown in FIG. 4, 1-8 may be performed and a device may continue to be in operation over time (e.g., as shown by n). 1-8 and/or n may illustrate (e.g., from a security perspective) one or more functions or actions that may be part of a connected device's lifecycle. As shown, the life of the device may start with a manufacture phase including the hardware manufacture at 1 and software and configuration customization at 2 and 3. The next phase may be the deployment phase in which the device may customized to be able to operate for the network it may reside in and based on or according to its end customer requirements. As shown, one or more configurations may be provided, initiated, performed, and/or the like at installation (e.g., and may be distinguished from each other) though physical presence at 4, locally at 5, and/or remotely at 6 from a management server. The device may then be operation at 7 during the operational phase. The device may be taken out of service (e.g., out of operation at 7) with some regularity such that new software may be installed or for physical maintenance at 8. The device may continue to be operation and/or upgradeable over time (e.g., as shown by n). In this device life-cycle perspective, operation of the device in the operation phase may be provided and/or guaranteed (e.g., if the right security and/or safety mechanisms may be available din the other phases such as the manufacture and/or deployment phase).

A device oriented threat may be provided, considered, and/or used. For example, threats against the devices in the system may occur. There may also be threats against end-user units or back-end systems. In an example, the threats against end-user units or back-end systems may not be taken into account in one or more of the examples described herein. According to an example, with the respect to attacks against the devices, the systems and/or methods herein may take into account network based attacks, software based attacks against the device themselves, and/or the like (e.g., and may provide improved robustness and/or software integrity thereto).

High assurance security and safety embodiments or examples may be provided and/or used in one or more examples described herein. For example, high assurance security and safety embodiments or examples as described herein may be used in defense, avionics, finance sectors, and/or the like. In examples, such high assurance and safety embodiments or examples may have a number of important and fairly unique design requirements or requests. For example, design and implementation may be evaluated according to a standard such as common criteria. For methods such as common criteria to work, an evaluated target system (e.g., software and hardware) may have to be defined (e.g., the function the software may provide should be specified without dynamic features, and/or the like that may make it difficult or hard to evaluate from a security perspective) and small enough to be evaluated with reasonable efforts. Other common requirements or requests may include segmentation and separation that may be of special concern when security and safety may be involved.

In, for example, high assurance embodiments or examples, separation may translate to physical partitioning. For example, given a number of modules with different function and security level, each module may be assigned a dedicated hardware component such as a CPU. This may create a distributed system with clear boundaries and interfaces that may makes information flow analysis feasible. Unfortunately, there also may be one or more disadvantageous to this approach. For example, it may generally results in large, complex and inefficient systems, for example, in terms of power consumption, size, development and manufacturing cost, and/or the like.

An alternative or additional example to physical partitioning may be or may include logical partitioning. With logical partitioning, one or more hardware components may be responsible for functionalities and separation may be guaranteed by other techniques such as, for example, in software. Such solutions may generally not be evaluated as a monolithic system due to their size and complexity. But, in an example such as with careful partitioning and separation of logic, it may be possible to design, implement and evaluate such systems. One technique to do so may be the existence of a small trusted base that may enable or enforce separation of other components. This trusted base may be a separation kernel and may include a real-time OS, a microkernel or a type 1 hypervisor or equivalent thereof.

Different from this example, an alternative or additional manner or way of making separation may be the use of a type 2 hypervisor or equivalent thereof. Unlike a type 1 hypervisor, a type 2 hypervisor may not run directly on the hardware, but instead on top of the main operation system kernel. This may imply that the isolation given by a type 2 hypervisor may not be better than the isolation properties given by the underlying operation system. Typically such an operation system may complex and large and it may be hard to actually provide high-level isolation security guarantees for such system.

In an example herein, a M2M unit or device may be protected with a hypervisor protected Device Management AGent (DMAG). The DMAG may run on a tiny OS. The tiny OS may include a full, but tiny network stack and may have direct access to at least one network device interface. In examples, the full network stack may be able to set up arbitrary IP based network connections with a network peer and may include as described herein Contiki, TinyOS, and/or other operating system stacks. The management agent (e.g., DMAG) may associated with a Device Management back-end Server or System or Device Management Server or System (e.g., a DMS) that may include a device unique security association such that the back-end server may be an entity (e.g., the only entity) that the management agent may trust and may accept control commands to and/or from.

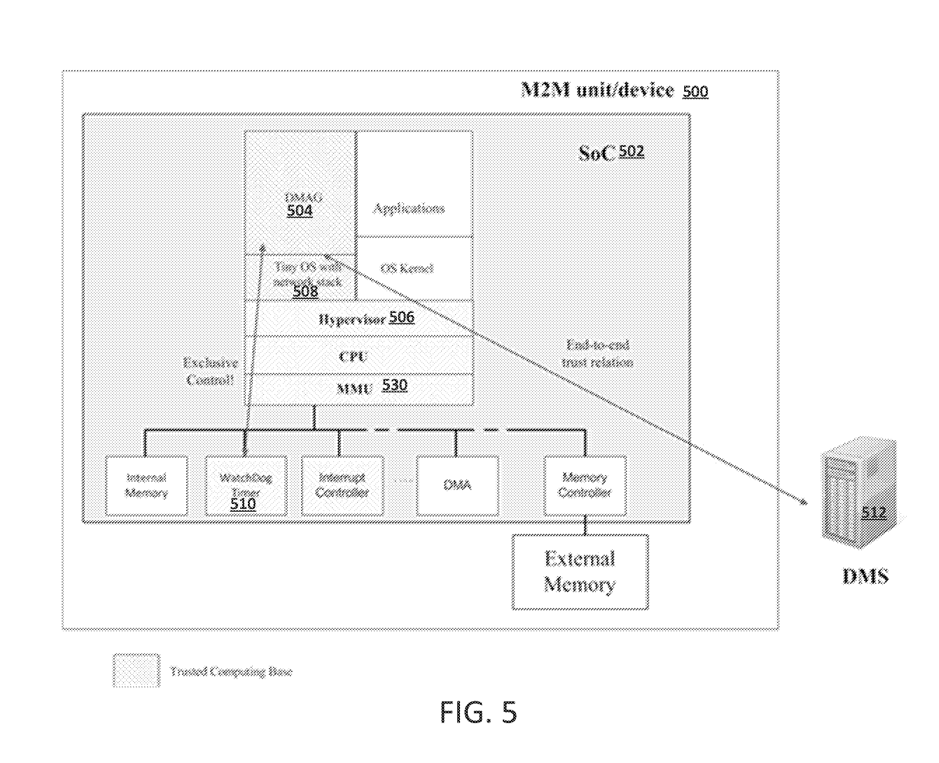

FIG. 5 illustrates an example high level system diagram that may be used to protect a M2M device or unit with a hypervisor protected DMAG that may run on a tiny OS as described herein. As shown in FIG. 5, a device 500 such as a M2M unit or device may include a system on a chip (SoC) 502. The SoC 502 may include a DMAG 504 that may be protected by a hypervisor 506. The DMAG 504 that include and/or run a tiny OS 508 as described herein. The DMAG may control a WatchDog timer 510. Additionally, in an example, the DMAG 504 may be in communication with a DMS 512. The DMS 512 may be an entity the DMAG 504 may trust and may send and/or receive commands or messages to and/or from.

In examples, the system (e.g., that may be shown in FIG. 5) may also include and/or have one or more of the following. The DMAG may have control of a memory management unit (MMU) (e.g., 530) and/or a secure WatchDog timer function (e.g., 510) that may be used. In an example, the MMU that may be in the CPU architecture may be an “arbiter” that may monitor CPU accesses in the system (e.g., the M2M unit and/or device 500). The MMU may grant or deny access to different system addresses based on a privileged mode of an application or software that may be calling the system. Typically, in examples, a CPU system or device may have at least two “rings” where software or applications that may execute on the more or most privileged ring may have full access to system resources while software or applications that may run in a less privileged ring may not have exclusive rights to each of the system resource and instead may have rights or may access resources that the MMU may allow it to access. The privileged part of the system may be responsible for configuring the MMU access control rules.

The secure WatchDog timer may reset functionality and in combination with the hypervisor functionality may make sure that the DMAG regularly gets control of the device. In an example, the DMAG may not get control of the device and the WatchDog functionality may force control to the agent (e.g., the DMAG) to ensure that the agent may get control. The agent such as the DMAG may be regularly in contact with the back-end server that may issue system reset commands.

According to an example, the DMAG or agent may get control after the WatchDog may time out. In an example (e.g., if the DMAG may get control after a WatchDog time out), the DMAG may contact the DMS that may issue a set of control commands to determine the cause of the WatchDog reset and may issue a set of reset commands such as re-flash that may put the device back to a functional state.

One or more of the examples such as the systems or methods described herein (e.g., as shown in FIG. 5) may enable or provide a cheaper device management solutions on many embedded architectures that may improve robustness or may be robust against attacks on the main system. One or more of the example methods described herein may enable the system (e.g., as shown in FIG. 5) to recover, for example, automatically from software configuration mistakes or software attacks on the main OS.

In an example, a Trusted Computing Base (TCB) may be provided and/or used. The TCB may be a set of hardware and software functions that may have been evaluated such that the user of the system may have a certainty (e.g., may be fairly sure) that such a set of the system may behave correctly (e.g., may not have a problem such as malware, and/or the like) and/or that it may not have a security hole and/or may not be as susceptible to attack, which may be why it may be trusted and/or a TCB. The TCB may be small and may include the hypervisor, the tiny OS and the DMAG to be trusted. The rest of the system such as that shown in FIG. 5 may be non-trusted or semi-trusted without jeopardizing the functionality thereof. This may be a different from a recovery system (e.g., as shown in FIG. 1) that may be dependent on a rich OS and or the system running on the main OS. As such, different from a type 1 hypervisor based approach (e.g., as shown in FIG. 2), the hypervisor, the tiny OS, and the DMAG may be on the trusted side or may be trusted and the rest of the system may be untrusted or semi-trusted. According to an example, an integrity of the hypervisor as well as the DMAG (e.g., to ensure they may be trusted) may be provided or guaranteed through a secure boot process on the system or device.

Additionally, one or more device management tasks such as heavy device management tasks may be performed by the DMS. Example of such heavy tasks may include, but may not be limited to, searching for and retrieving software or application and/or software or application configurations, advanced device diagnostics such as virus scan and version checks, and/or the like. As such, one or more of the example methods described herein may offload potential computational and power constraints on the device from computational and power demanding tasks.

An example herein may include having a failure and software attack recovery mechanism for resource constraint M2M units. According to this example, the system may recover from a severe software fault or software attack without direct manual intervention by a local operator with physical access of the device. Instead, a remote back-end management system may handle the recovery without the use of physical presence.

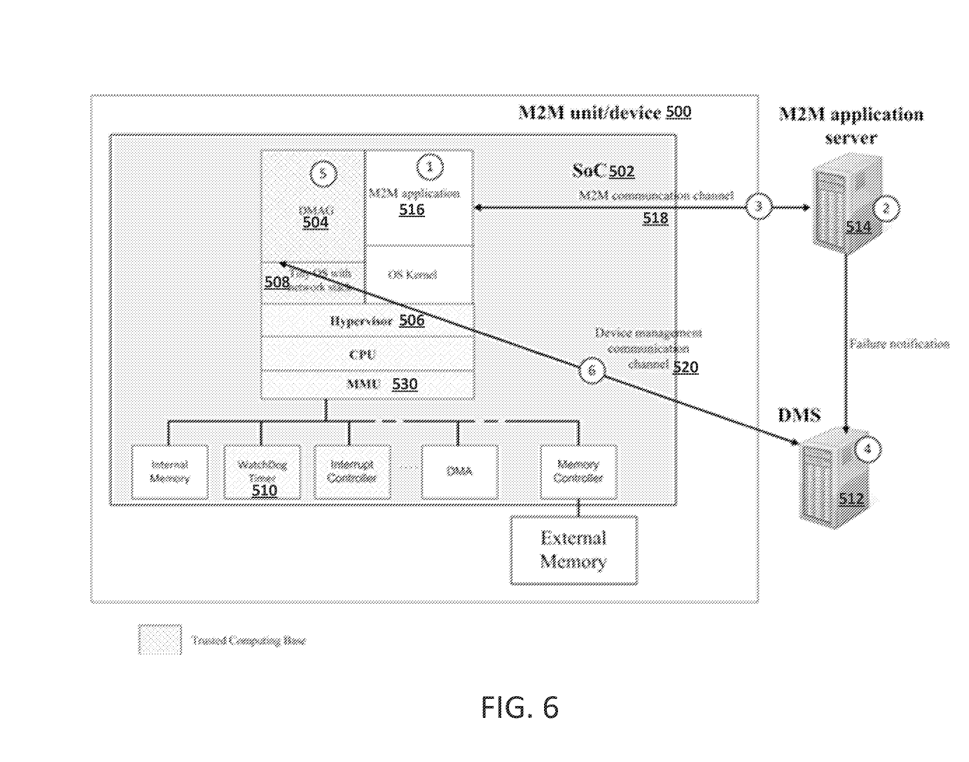

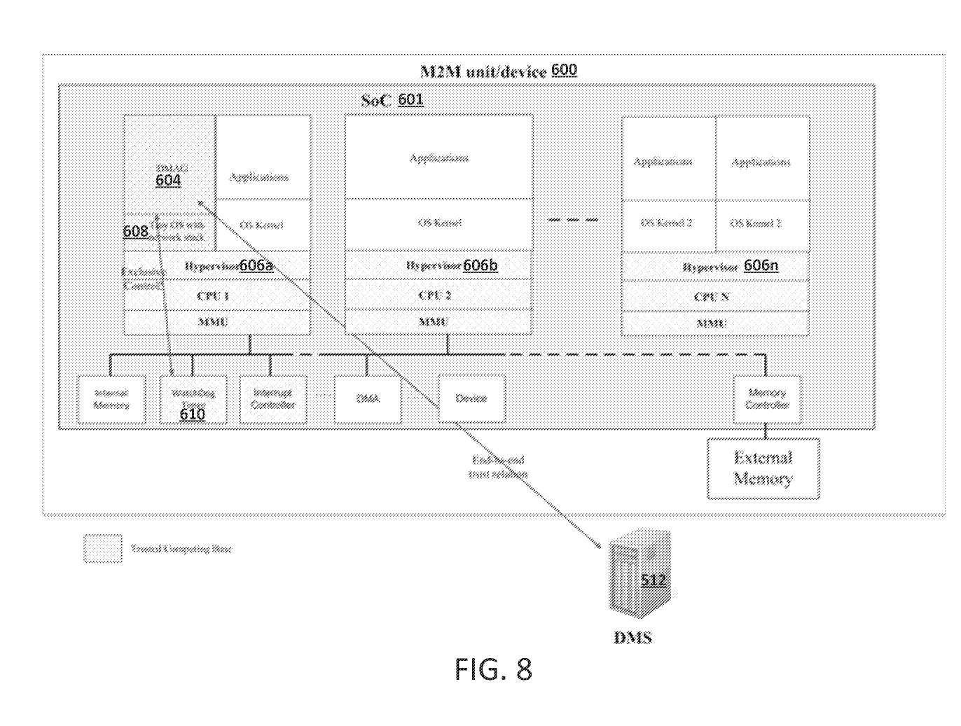

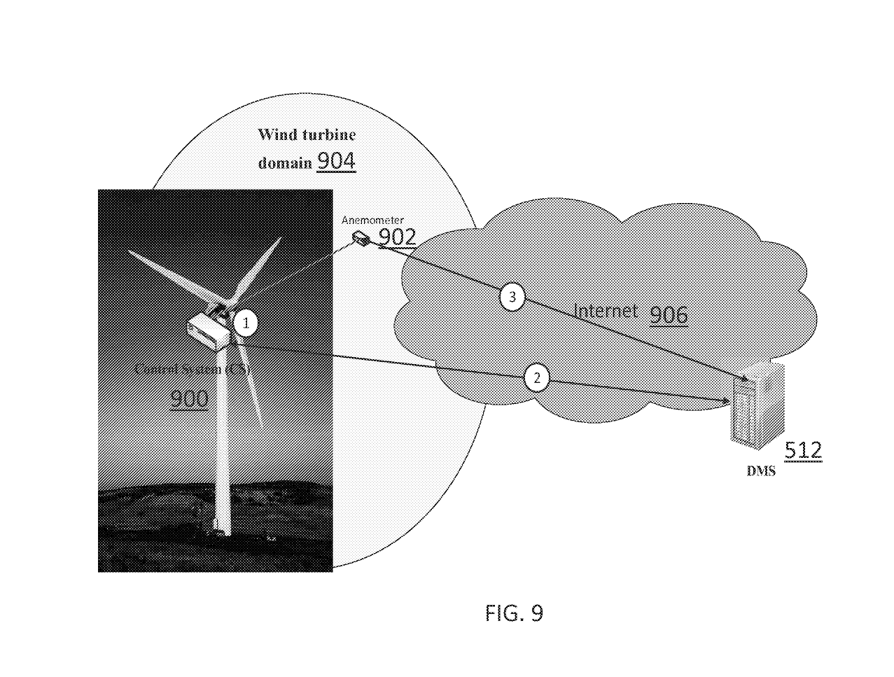

One or more of the examples described herein may be provided or used on a single CPU embedded system in an embodiment (e.g., shown in FIGS. 5 and 6). However, the principles may be extended to a multi core embedded system (e.g., shown in FIG. 8). Additionally, the principles may be implemented in various industrial or real-world systems including, for example, power systems such as wind power systems as shown in FIG. 8, manufacturing systems such as food processing systems as shown in FIG. 9, and/or the like.

The M2M unit device recovery system may include one or more of the following core functions or actions. For example, a partition of the an embedded system with a thin hypervisor (e.g., and in turn an MMU or a memory protection unit (MPU)) may be provided such that the main OS may run in isolated secure execution environment that may include a first Virtual Machine (VM), and a DMAG that runs in a parallel (other). The main OS may further run in a second VM that may be securely separated from the isolated secure execution environment and/or the first VM such that the first VM running in the secure execution environment may not influence the execution of the second VM running separately, for example, except through a defined hypervisor provided application programming interface (API) that may not compromise the security of the hypervisor or the device management agent.

Further, the hypervisor may have control (e.g., full control) of the MMU or MPU on the system. In an example, the hypervisor may make sure that the non-trusted part of the system such as the main OS may not have memory access to one or more of the following: the boot code and the data used by the secure boot process; the WatchDog reset timer on the SoC; the hypervisor code and data used by the hypervisor; the tiny OS and the device management agent and the data used by these entities; and/or the like.

In an example, the DMAG and the DMS may have a trust relation. For example, the DMAG and the DMS may have a trust relation based on cryptographic keys that may be used to set up a secure communication channel between the DMAG and the DMS. This may include a shared symmetric key or public keys embedded in certificates, and/or the like. These keys may be used to set up secure sessions between DMAG and DMS protected by temporary session keys.

Additionally, in an example, the hypervisor and the DMAG may be booted with a secure boot process. In such an example, a trusted boot code that may be located in ROM or flash memory may perform or make an integrity check of the hypervisor prior to launch. The trusted boot code may also perform or make an integrity check of the tiny OS and the device management agent prior to the hypervisor such that these services may be launched in a trusted VM. According to an example, the integrity check may fail. The system may be not booted in an example (e.g., if the integrity check fails) and/or a recovery DMAG routine (e.g., with access to the key material used to set up a secure session with DMS) may be started. The recovery DMAG routine may contact the DMS that may be trying to recover the system through a re-flash in one example.

As described herein, the hypervisor may provide or use a WatchDog timer. The WatchDog timer may be used to maintain an API to the non-trusted portion or part of the system such as the main OS. The hypervisor or another component may enable or allow the non-trusted OS to call a routine in the DMAG that may keep the WatchDog timer alive. A WatchDog timer reset may also occur or be performed. In an example, (e.g., if a WatchDog timer reset occurs or may be performed), a dedicated interrupt routine may be invoked and may encompass or use the DMAG such that the dedicated interrupt routine may take over the execution. Such a routine may perform, cause, or include one or more of the following. In the routine, the DMAG may contact the device management back-end system by setting up a secure communication channel between the DMAG and the DMS. The DMS may use this secure channel to issue a set of diagnostic commands. In an example, a root cause to the WatchDog reset may not be identified or determined and/or fixed. In such an example (e.g., if the root cause to the WatchDog reset cannot be identified and fixed in a direct way), the DMS may send a new software packages to the device and request a re-flash of the system. One or more other recovery options or procedures may be used or invoked and the examples herein may not be limited to a particular recovery option.

According to additional examples, the DMAG with some regularity may be provided or given execution rights. If such rights may not be given, according to an example, the WatchDog timer may make sure the DMAG gets this right. The DMAG may choose to contact the DMS that may issue pending device management commands towards the device. The DMS may also contact the system running on the first VM (e.g., the isolated secure execution environment) and may request it to request the DMAG to contact the DMS for device management. This may be done through a dedicated hypervisor API call.

In an example, an external communication that may be performed by the DMAG may be an external communication with the DMS. As such, according to an example, the DMAG may initiate external network requests that may be directed towards or to a limited number of trusted external device management entities such as the DMS, and/or the like. This may help enable or ensure that the DMAG may be protected from network-based attacks, DoS attacks, and/or the like. Additionally, in an example, the DMAG (e.g., to be protected from external attacks such as external DoS attacks) may not accept or may deny an external network request such as an external network connection request. Furthermore, the DMAG may initiate communication with the DMS preventing denial-of-service attacks through session invitations from external network entities.

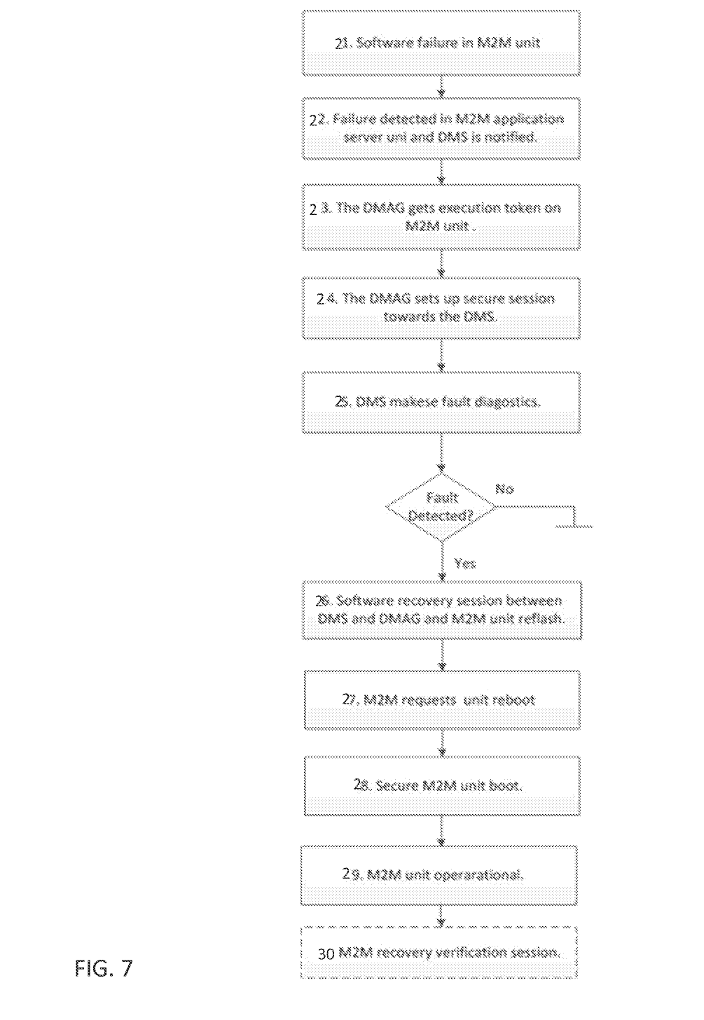

FIG. 6 illustrates an example of a device recovery or system setting or method that may be used by or performed on a system or device such as the device 500. Such a device recovery or system setting may show one example system or device view and alternative system deployments may be used and/or possible. For example, a M2M application server (e.g., 514) may in another setting or example be an end user device such as smart phone, tablet or PC or the like. FIG. 7 illustrates an example device recovery procedure or method 700 that may be performed or involved in a software fault or software attack according to one or more examples herein. In an example, the procedure or method 700 may be performed by the system 500 shown in FIGS. 5 and 6.

As shown, at 21, due to a software failure or a software attack, a M2M application (e.g., 516 of FIG. 5 and as shown by 1) running on the main OS of an M2M unit may not be working as expected (e.g., may not be in a normal service). According to an example, the system not working as expected and/or not being in the normal service may be, for example, due to network communication being stopped in a Denial of Service (DoS) attack by a virus on the M2M unit and/or the operation of the M2M in some other means being disturbed or prevented. This fault behavior may be detected as the application may no longer be able to be reached by an M2M application backend server (e.g., 514 of FIG. 6 and shown by 2) communicating with the M2M application through a communication channel (e.g., 518 of FIG. 6 and as shown by 3). It may also be detected as an interrupt of the service provided by the M2M unit to the M2M application server.

At 22, the application M2M server may notice that it may have a problem reaching or communicating with the M2M application or that the behavior may not be as expected (e.g., may not be in the normal service). According to examples, the application M2M server may determine whether the problem may be based on network connectivity (e.g., by pinging a nearby M2M unit). In an example (e.g., after excluding that the problem may be due to network connectivity by pinging a nearby M2M unit), the M2M server may send a failure notification to the DMS (e.g., 512 of FIG. 6 and as shown by 4) that may inform the DMS that the particular M2M unit may not be working as expected. In an example, a particular M2M unit that may be subject to or may have a potential software failure may be indicated by sending the unique ID of the M2M unit (e.g., in the message or failure notification).

The M2M unit application and/or the operating system running the M2M application may be out of the normal service. The application and/or operating system being out of the normal service may indicate or imply that the normal hand over to the DMAG through a hyper call to keep the WatchDog timer (e.g., 510 of FIG. 6) alive may not occur or be able to happen. According to an example such as eventually due to a watchdog reset, the DMAG (e.g., 504 of FIG. 6 and as shown by 5) may perform or get execution control, at 23, and may be scheduled for execution by the hypervisor. As such, the DMAG may get control, at 23, when, based on a determination, the application and/or the OS may not be in the normal service. As described herein (e.g., above), the DMAG may get control as a result of the WatchDog timer being reset or a reset occurring by force (e.g., if a WatchDog timer may be kept alive). For example (e.g., if the WatchDog timer may be kept alive by the device or system), the WatchDog function may be executed and its execution may be handed over by force to the DMAG using the device and/or its hardware and the hypervisor (e.g., 506 of FIG. 6) as described herein. As such, the hypervisor and device may hand over functionality to the DMAG via the WatchDog timer (e.g., a reset thereof), for example, if the hypervisor and/or device may determine the system may be compromised (e.g., the application and/or OS may not be in the normal service or may be out of the normal service). According to an example, the DMAG may include or may have information and/or may receive an indication that the handover that may have occurred due to a WatchDog timer reset and, consequently, may know that the hand over occurred due to a failure in the normal system. As such, the DMAG getting control due to the WatchDog timer reset may be used by the DMAG to determine or detect that the application and/or OS may not be in the normal service. Alternatively or additionally, the DMAG may be scheduled by a hyper call from the main VM that may at least partially work as expected.

In an example, at 24, the DMAG may imitate or initiate a secure session towards the DMS. As such, a secure channel (e.g., 520 of FIG. 6 and as shown by 6) such as for instance a DTLS or an IKE/IPSEC secure connection may be established between the M2M application and the M2M server application (e.g., the secure session being initiated may include the secure channel establishment). According to an example, as part of the secure channel setup, the M2M unit is authenticated and identified through its unique M2M ID.

At 25, in an example, the DMS may further check or access a failure notification register and may determine or find out whether the particular M2M unit may have a potential software problem and/or the reason for the problem. For example, the failure notification may be received and stored in a register or table (e.g., memory associated therewith). The DMS may check the register or table at 25 to determine whether a particular M2M unit such as the unit or device 500 may have a software problem or a potential software problem.

At 26, the DMS and DMAG may set up a software recovery and/or upgrade session. According to an example, a software image such as a new software image may be transferred to the DMAG or an existing back-up image on the M2M persistence storage medium may be used by the DMAG to do a re-flash of the main operating system and the applications running on the main operation system.

At 27, the DMAG may issue a re-boot request command of the M2M system (e.g., the M2M unit or device). The M2M device or unit (e.g., the system or M2M system) may be rebooted based on the command. For example, the re-boot request command may force a hardware reboot of the system (e.g., the M2M unit or device 500) such that the system may shut down, reset and clear volatile memories and may then start-up again.

At 28, the tiny OS and/or the DMAG may be checked by a secure boot process that may be on the M2M unit (e.g., during reboot the integrity of the hypervisor). The secure boot code may be protected from modification by physical isolation and/or rewrite protection. The secure boot code may also verify an integrity of the main OS and the M2M application running on the main OS. Example of secure a secure boot process may include, but may not be limited to, a process where the boot code may reside in integrity protected memory (e.g., memory that may hard for an attacker to modify) and/or where the boot code may perform integrity checks of software or application blocks including operating system blocks that may be loaded into volatile memory during the boot. Such integrity checks may include one or more of the following: a check of one-way hash function, a check of a digital signature or a so-called Message Authentication Code (MAC), and/or the like.

At 29, the M2M application may be running again. For example, once re-booted or re-boot may be complete, the M2M application may be up and running again.

At 30 (e.g., optionally), the DMS may issue a set of diagnostics commands towards the M2M unit and the applications running on the M2M units to make sure it works at expected. For example, once the M2M device or unit may be rebooted, the DMS may issue the set of diagnostics command thereto. Alternatively or additionally, the M2M application server maybe informed that the system (e.g., the device or unit) may have been reset and it may be asked to check that the service may be running as expected again.

As described herein, the examples herein may be deployed or implemented on a single core embedded system. For example, the disclosed or described examples may be can be realized in several different ways including on a single core system as depicted in FIG. 5 (and FIG. 6). According to this embodiment, the DMAG may be in a separate VM on top on a tiny OS in a single core system that may share the main CPU with the main VM where the main OS and main application may be running A hypervisor running in a privileged mode such as a most privileged mode on the CPU may provide or may make sure the security critical VM (e.g., where the tiny OS and DMAG runs) may be securely separated from the rest of the system. Example of hypervisors to be used for this configuration may include, but may not be, limited to a microkernel OKL4, Pike OS, a SICS thin hypervisor, and/or the like. Use of a tiny OS on the protected VM side of the system may enable or may make sure the security properties of the OS may be verified with high assurance level with reasonable efforts. In an example (e.g., at the same time), the tiny OS may run a network stack such as a full network stack such that the DMAG may have a reliable communication with the DMS to run a recovery session. Examples of the OSs that may be used may include, but may not be limited to, Tiny OS, Contiki OS, and/or the like. As described above, the network stack functionality may include functionality to set up an Internet Protocol (IP) connection to one or more arbitrary peers on a network such as an internal network or the Internet through suitable available network hardware interfaces on the device.

The examples described herein may further be deployed or implemented on a multi-core embedded system. For example, the examples described herein may be used in a system with multiple CPUs. Unlike a single CPU system (e.g., shown in FIGS. 5 and 6), this option or example may use multiple VMs on one of the CPUs. Additionally, multiple VMs may be run or used on the other CPUs. FIG. 8 illustrates an example of an implementation of the examples herein on multiple CPUs.

In a multi-core deployment of a M2M unit or device (e.g., 600), a hypervisor (e.g., 606a-606n) may be running on each of the cores to make sure that the untrusted or semiuntrusted main OS or OSs running on the cores may not access security critical units on a SoC (e.g., 601) such as WatchDog timer (e.g., 610) and/or may be an interrupt controller, and/or the like as the hypervisor may be running in a privileged CPU mode such as the most privileged CPU mode on the system. This may imply or may provide that even if multiple VMs may not be running on one or several of the cores, a hypervisor may be present on these cores to not compromise the security of the system. The DMAG (e.g., 604) may be present on one of the cores such as on CPU 2 according to the example in FIG. 8. According to an example, there may not be anything that may prevent deploying the examples herein such that multiple DMAGs may be used or present in the system running on several of the cores in the system. In such an example, there may be a synchronization mechanism between the different DMAGs in the system.

A restore session may occur. In an example (e.g., when a restore session may occur as described herein, the DMAG and the tiny OS running in the trusted VM may get, receive, or have unique access right to the network resource of the device. This may be provided or ensured by the hypervisors running in the system that may give rights such as this exclusive right the DMAG (e.g., when requested through a dedicated hyper call in an example).

Example of hypervisors that may be used in this configuration (e.g., shown in FIG. 8) may include, but may not be limited to, a microkernel OKL4, a Pike OS, possibly a SICS thin hypervisor (e.g., in the future as it may not currently not support multicore), and/or the like. Use of a tiny OS on the protected VM side of the system may provide or may make sure the security properties of the OS may be verified with high assurance level with reasonable efforts. Additionally, in an example, the OS may run a network stack such as a full network stack such that the DMAG may have a reliable communication with the DMS to run a recovery session. Examples this OS that may be used may include, but may not be limited to, Tiny OS, Contiki OS, and/or the like.

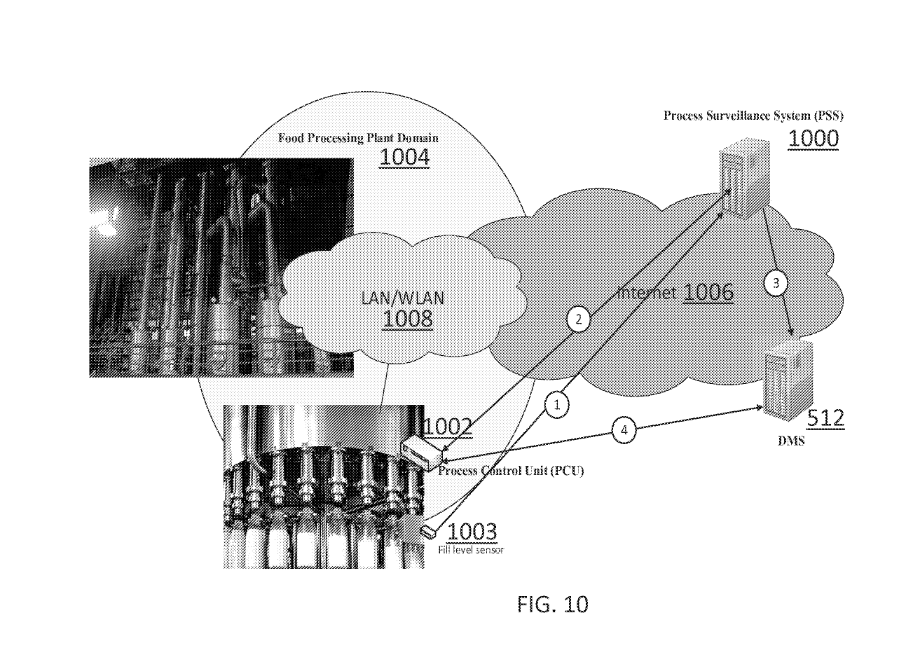

FIGS. 9-10 illustrate examples in which the systems and/or methods herein for performing device recovery may be implemented and/or used. As shown in FIG. 9, a control system (CS) 900 and/or an anemometer 902 that may be and/or may include components of an M2Munit and/or device such as the M2M unit or device 500 and/or 600 as described herein may be implemented in and/or associated with a power system such as a wind turbine in, for example, a wind turbine domain 904. According to an example, the anemometer 902 may be a single core anemometer with components similar to the unit or device 500 and may be running a DMAG (e.g., 504) as described herein. As shown, at 1, the CS 900 may not get an accurate wind measurement from the anemometer 902. At 2, the CS 900 may contact a DMS (e.g., 512) that may responsible for managing the anemometer 902 and may be in communication with the wind turbine domain 904 including the CS 900 and/or anemometer 902 via a network such as the Internet 906. In an example, at 2, the CS may contact the DMS 512 by sending a message and/or the like that may indicate to the DMS 512 that the anemometer 902 may have a failure. The DMS 512 and anemometer 902 may then perform device recovery (e.g., the method of FIG. 6) to recover from the failure at 3. For example, at 3, the DMAG (e.g., 504) that may be in the anemometer 902 may contact and/or communicate with the DMS 512 as described herein in examples to receive and/or send a software reset message, and/or the like from the DMS 512 such that the anemometer and/or components therein such as the DMAG (e.g., 504) may be reset, re-booted, and/or the like to enable it to recover from the failure and be running again.

As shown in FIG. 10, a process surveillance system (PSS) 1000 may be in communication (e.g., via a network such as the Internet 1006 and/or a LAN/WAN 1008) with a process control unit (PCU) 1002 and/or an fill level sensor 1003 that may be and/or may include components of an M2M unit and/or device such as the M2M unit or device 500 and/or 600 as described herein. The PCU 1002 and/or the fill level sensor 1003 may be implemented in and/or associated with a manufacturing system such as a food processing system in, for example, a food processing plant domain 1004. According to an example, the PCU 1002 may be a multi-core device or unit with components similar to the unit or device 600 and may be running a DMAG (e.g., 604) as described herein. As shown, at 1, the PSS 1000 may receive information that a fill level (e.g., that may be monitored by the fill level sensor 1003 and therefrom) may not be at an expected level or a level above a threshold. At 2, the PSS 1000 (e.g., in response to the fill level not being at a level expected or below a threshold) may try or attempt to connect to the PCU 1002 (e.g., or a quit power function thereof) that may be running the DMAG (e.g., 604) and that may be controlling the fill level sensor 1003. In an example, the fill level may not be as expected or above the threshold as a result of a software fault in the PCU 100 at 2. At 3 (e.g., in response to not being able to connect to the PCU 1002 and/or it not being able to control the fill level sensor 1003, and/or the like), the PSS 100 may contact and/or communicate with the DMS 512 that may be responsible for managing the PCU 1002 and may indicate thereto (e.g., in a message) that the PCU 1002 may have a failure (e.g., a severe failure). The DMS 512 and PCU 1002 may then perform device recovery (e.g., the method of FIG. 6) to recover from the failure at 4. For example, at 4, the DMAG (e.g., 604) that may be in the PCU 1002 may contact and/or communicate with the DMS 512 as described herein in examples to receive and/or send a software reset message, and/or the like from the DMS 512 such that the PCU and/or components therein such as the DMAG (e.g., 604) may be re-set, re-booted, and/or the like to enable it to recover from the failure and be running again.

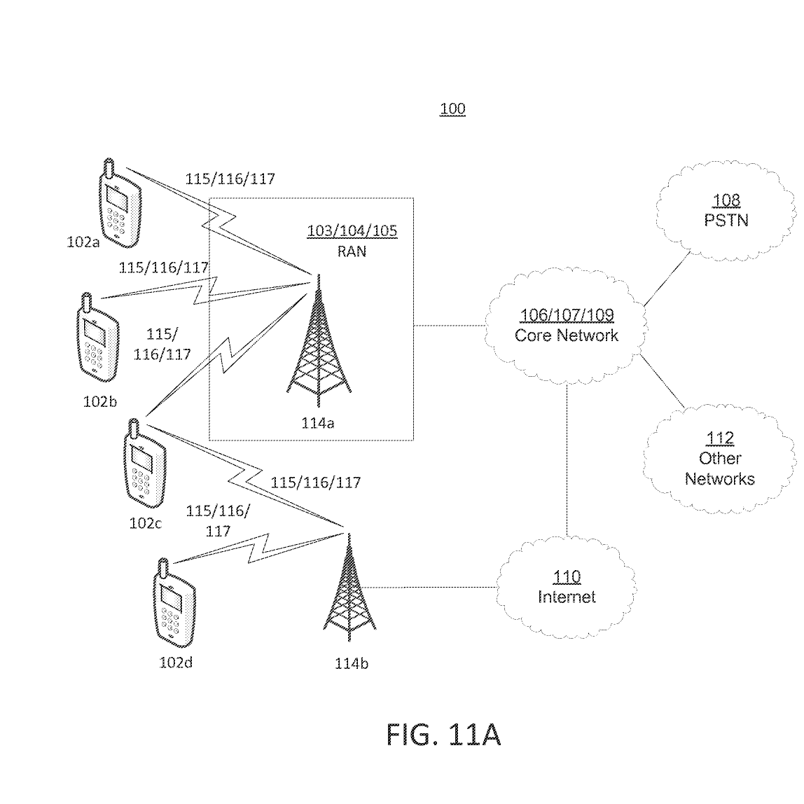

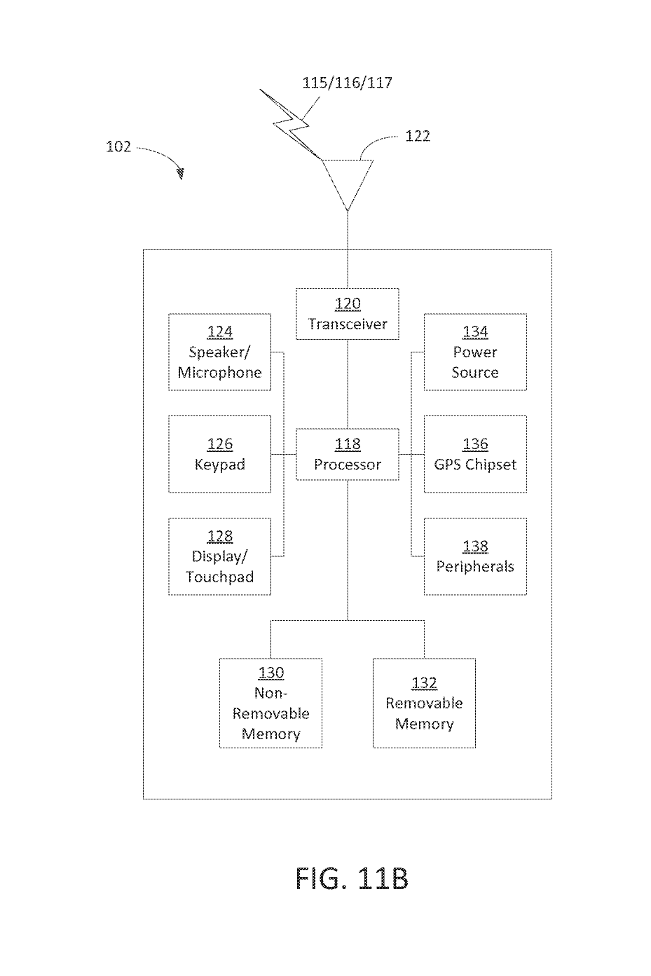

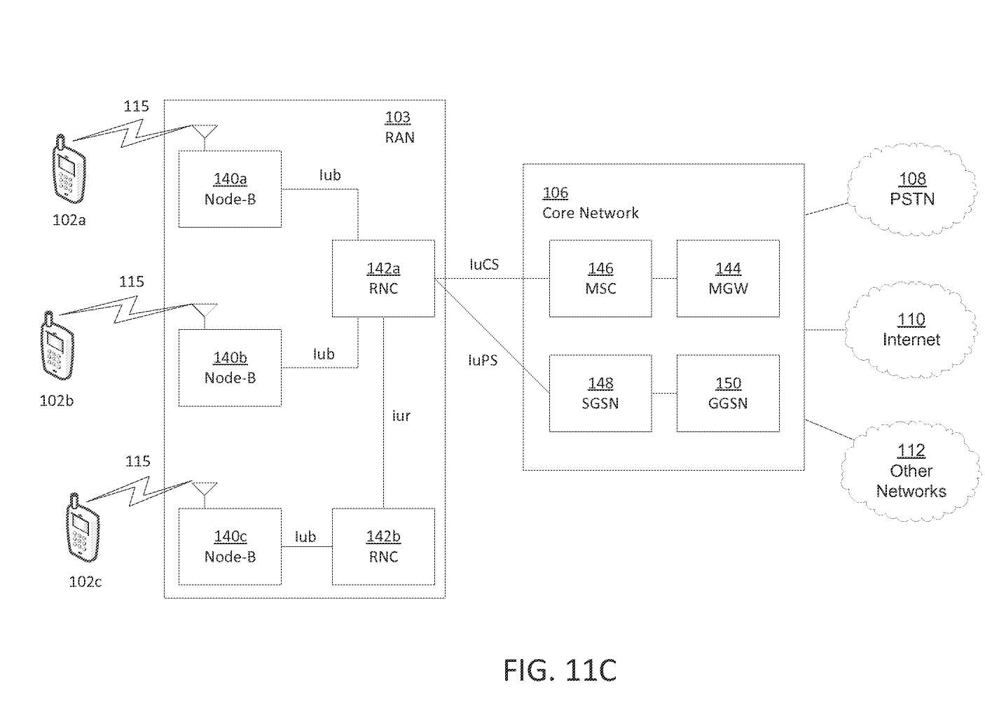

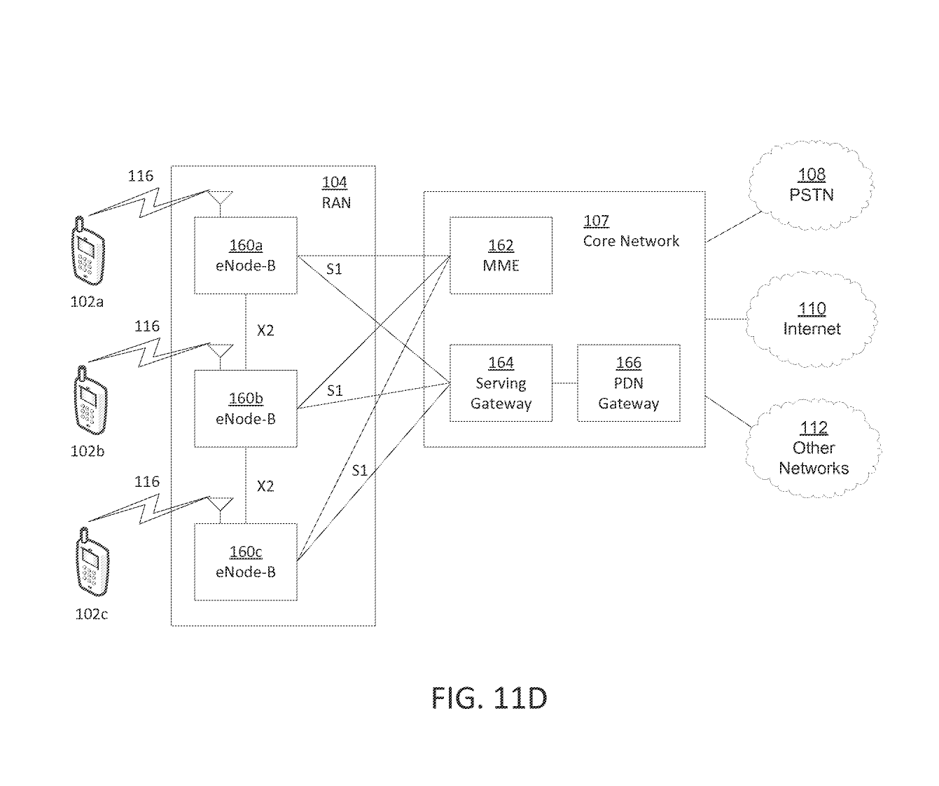

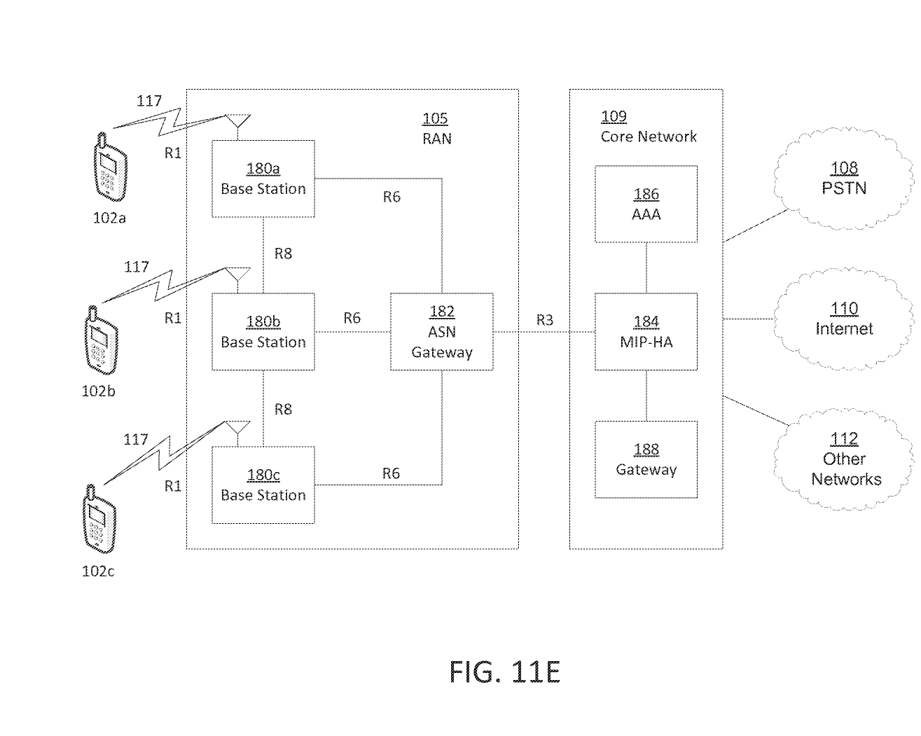

FIG. 11A depicts a diagram of an example communications system 100 in which one or more disclosed embodiments or examples may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), and the like.

As shown in FIG. 11A, the communications system 100 may include wireless transmit/receive units (WTRUs) 102a, 102b, 102c, and/or 102d (which generally or collectively may be referred to as WTRU 102), a radio access network (RAN) 103/104/105, a core network 106/107/109, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, and/or 102d may be any type of device configured to operate and/or communicate in a wireless environment. By way of example, the WTRUs 102a, 102b, 102c, and/or 102d may be configured to transmit and/or receive wireless signals and may include user equipment (UE), a mobile station, a fixed or mobile subscriber unit, a pager, a cellular telephone, a personal digital assistant (PDA), a smartphone, a laptop, a netbook, a personal computer, a wireless sensor, consumer electronics, and the like.

The communications systems 100 may also include a base station 114a and a base station 114b. Each of the base stations 114a, 114b may be any type of device configured to wirelessly interface with at least one of the WTRUs 102a, 102b, 102c, and/or 102d to facilitate access to one or more communication networks, such as the core network 106/107/109, the Internet 110, and/or the networks 112. By way of example, the base stations 114a and/or 114b may be a base transceiver station (BTS), a Node-B, an eNode B, a Home Node B, a Home eNode B, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 103/104/105, which may also include other base stations and/or network elements (not shown), such as a base station controller (BSC), a radio network controller (RNC), relay nodes, etc. The base station 114a and/or the base station 114b may be configured to transmit and/or receive wireless signals within a particular geographic region, which may be referred to as a cell (not shown). The cell may further be divided into cell sectors. For example, the cell associated with the base station 114a may be divided into three sectors. Thus, in one embodiment, the base station 114a may include three transceivers, i.e., one for each sector of the cell. In another embodiment, the base station 114a may employ multiple-input multiple output (MIMO) technology and, therefore, may utilize multiple transceivers for each sector of the cell.

The base stations 114a and/or 114b may communicate with one or more of the WTRUs 102a, 102b, 102c, and/or 102d over an air interface 115/116/117, which may be any suitable wireless communication link (e.g., radio frequency (RF), microwave, infrared (IR), ultraviolet (UV), visible light, etc.). The air interface 115/116/117 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 103/104/105 and the WTRUs 102a, 102b, and/or 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In another embodiment, the base station 114a and the WTRUs 102a, 102b, and/or 102c may implement a radio technology such as Evolved UMTS Terrestrial Radio Access (E-UTRA), which may establish the air interface 115/116/117 using Long Term Evolution (LTE) and/or LTE-Advanced (LTE-A).

In other embodiments, the base station 114a and the WTRUs 102a, 102b, and/or 102c may implement radio technologies such as IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 11A may be a wireless router, Home Node B, Home eNode B, or access point, for example, and may utilize any suitable RAT for facilitating wireless connectivity in a localized area, such as a place of business, a home, a vehicle, a campus, and the like. In one embodiment, the base station 114b and the WTRUs 102c, 102d may implement a radio technology such as IEEE 802.11 to establish a wireless local area network (WLAN). In another embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, etc.) to establish a picocell or femtocell. As shown in FIG. 11A, the base station 114b may have a direct connection to the Internet 110. Thus, the base station 114b may not be required to access the Internet 110 via the core network 106/107/109.

The RAN 103/104/105 may be in communication with the core network 106/107/109, which may be any type of network configured to provide voice, data, applications, and/or voice over internet protocol (VoIP) services to one or more of the WTRUs 102a, 102b, 102c, and/or 102d. For example, the core network 106/107/109 may provide call control, billing services, mobile location-based services, pre-paid calling, Internet connectivity, video distribution, etc., and/or perform high-level security functions, such as user authentication. Although not shown in FIG. 11A, it will be appreciated that the RAN 103/104/105 and/or the core network 106/107/109 may be in direct or indirect communication with other RANs that employ the same RAT as the RAN 103/104/105 or a different RAT. For example, in addition to being connected to the RAN 103/104/105, which may be utilizing an E-UTRA radio technology, the core network 106/107/109 may also be in communication with another RAN (not shown) employing a GSM radio technology.

The core network 106/107/109 may also serve as a gateway for the WTRUs 102a, 102b, 102c, and/or 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and the internet protocol (IP) in the TCP/IP internet protocol suite. The networks 112 may include wired or wireless communications networks owned and/or operated by other service providers. For example, the networks 112 may include another core network connected to one or more RANs, which may employ the same RAT as the RAN 103/104/105 or a different RAT.

Some or all of the WTRUs 102a, 102b, 102c, and/or 102d in the communications system 100 may include multi-mode capabilities, i.e., the WTRUs 102a, 102b, 102c, and/or 102d may include multiple transceivers for communicating with different wireless networks over different wireless links. For example, the WTRU 102c shown in FIG. 11A may be configured to communicate with the base station 114a, which may employ a cellular-based radio technology, and with the base station 114b, which may employ an IEEE 802 radio technology.

FIG. 11B depicts a system diagram of an example WTRU 102 in which one or more of the examples or embodiments may be implemented in (e.g., which may have a hypervisor and/or may use a Watchdog timer and/or other examples as described herein). As shown in FIG. 11B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and other peripherals 138. It will be appreciated that the WTRU 102 may include any sub-combination of the foregoing elements while remaining consistent with an embodiment. Also, embodiments contemplate that the base stations 114a and 114b, and/or the nodes that base stations 114a and 114b may represent, such as but not limited to transceiver station (BTS), a Node-B, a site controller, an access point (AP), a home node-B, an evolved home node-B (eNodeB), a home evolved node-B (HeNB), a home evolved node-B gateway, and proxy nodes, among others, may include some or all of the elements depicted in FIG. 11B and described herein.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 11B depicts the processor 118 and the transceiver 120 as separate components, it may be appreciated that the processor 118 and the transceiver 120 may be integrated together in an electronic package or chip.

The transmit/receive element 122 may be configured to transmit signals to, or receive signals from, a base station (e.g., the base station 114a) over the air interface 115/116/117. For example, in one embodiment, the transmit/receive element 122 may be an antenna configured to transmit and/or receive RF signals. In another embodiment, the transmit/receive element 122 may be an emitter/detector configured to transmit and/or receive IR, UV, or visible light signals, for example. In yet another embodiment, the transmit/receive element 122 may be configured to transmit and receive both RF and light signals. It will be appreciated that the transmit/receive element 122 may be configured to transmit and/or receive any combination of wireless signals.

In addition, although the transmit/receive element 122 is depicted in FIG. 11B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 115/116/117.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as UTRA and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 115/116/117 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs or video), a universal serial bus (USB) port, a vibration device, a television transceiver, a hands free headset, a Bluetooth® module, a frequency modulated (FM) radio unit, a digital music player, a media player, a video game player module, an Internet browser, and the like.

FIG. 11C depicts a system diagram of the RAN 103 and the core network 106 according to an embodiment. As noted above, the RAN 103 may employ a UTRA radio technology to communicate with the WTRUs 102a, 102b, and/or 102c over the air interface 115. The RAN 103 may also be in communication with the core network 106. As shown in FIG. 11C, the RAN 103 may include Node-Bs 140a, 140b, and/or 140c, which may each include one or more transceivers for communicating with the WTRUs 102a, 102b, and/or 102c over the air interface 115. The Node-Bs 140a, 140b, and/or 140c may each be associated with a particular cell (not shown) within the RAN 103. The RAN 103 may also include RNCs 142a and/or 142b. It will be appreciated that the RAN 103 may include any number of Node-Bs and RNCs while remaining consistent with an embodiment.

As shown in FIG. 11C, the Node-Bs 140a and/or 140b may be in communication with the RNC 142a. Additionally, the Node-B 140c may be in communication with the RNC142b. The Node-Bs 140a, 140b, and/or 140c may communicate with the respective RNCs 142a, 142b via an Iub interface. The RNCs 142a, 142b may be in communication with one another via an Iur interface. Each of the RNCs 142a, 142b may be configured to control the respective Node-Bs 140a, 140b, and/or 140c to which it is connected. In addition, each of the RNCs 142a, 142b may be configured to carry out or support other functionality, such as outer loop power control, load control, admission control, packet scheduling, handover control, macrodiversity, security functions, data encryption, and the like.

The core network 106 shown in FIG. 11C may include a media gateway (MGW) 144, a mobile switching center (MSC) 146, a serving GPRS support node (SGSN) 148, and/or a gateway GPRS support node (GGSN) 150. While each of the foregoing elements are depicted as part of the core network 106, it will be appreciated that any one of these elements may be owned and/or operated by an entity other than the core network operator.

The RNC 142a in the RAN 103 may be connected to the MSC 146 in the core network 106 via an IuCS interface. The MSC 146 may be connected to the MGW 144. The MSC 146 and the MGW 144 may provide the WTRUs 102a, 102b, and/or 102c with access to circuit-switched networks, such as the PSTN 108, to facilitate communications between the WTRUs 102a, 102b, and/or 102c and traditional land-line communications devices.

The RNC 142a in the RAN 103 may also be connected to the SGSN 148 in the core network 106 via an IuPS interface. The SGSN 148 may be connected to the GGSN 150. The SGSN 148 and the GGSN 150 may provide the WTRUs 102a, 102b, and/or 102c with access to packet-switched networks, such as the Internet 110, to facilitate communications between and the WTRUs 102a, 102b, and/or 102c and IP-enabled devices.

As noted above, the core network 106 may also be connected to the networks 112, which may include other wired or wireless networks that are owned and/or operated by other service providers.

FIG. 11D depicts a system diagram of the RAN 104 and the core network 107 according to an embodiment. As noted above, the RAN 104 may employ an E-UTRA radio technology to communicate with the WTRUs 102a, 102b, and/or 102c over the air interface 116. The RAN 104 may also be in communication with the core network 107.

The RAN 104 may include eNode-Bs 160a, 160b, and/or 160c, though it will be appreciated that the RAN 104 may include any number of eNode-Bs while remaining consistent with an embodiment. The eNode-Bs 160a, 160b, and/or 160c may each include one or more transceivers for communicating with the WTRUs 102a, 102b, and/or 102c over the air interface 116. In one embodiment, the eNode-Bs 160a, 160b, and/or 160c may implement MIMO technology. Thus, the eNode-B 160a, for example, may use multiple antennas to transmit wireless signals to, and receive wireless signals from, the WTRU 102a.

Each of the eNode-Bs 160a, 160b, and/or 160c may be associated with a particular cell (not shown) and may be configured to handle radio resource management decisions, handover decisions, scheduling of users in the uplink and/or downlink, and the like. As shown in FIG. 11D, the eNode-Bs 160a, 160b, and/or 160c may communicate with one another over an X2 interface.

The core network 107 shown in FIG. 11D may include a mobility management gateway (MME) 162, a serving gateway 164, and a packet data network (PDN) gateway 166. While each of the foregoing elements are depicted as part of the core network 107, it will be appreciated that any one of these elements may be owned and/or operated by an entity other than the core network operator.

The MME 162 may be connected to each of the eNode-Bs 160a, 160b, and/or 160c in the RAN 104 via an S1 interface and may serve as a control node. For example, the MME 162 may be responsible for authenticating users of the WTRUs 102a, 102b, and/or 102c, bearer activation/deactivation, selecting a particular serving gateway during an initial attach of the WTRUs 102a, 102b, and/or 102c, and the like. The MME 162 may also provide a control plane function for switching between the RAN 104 and other RANs (not shown) that employ other radio technologies, such as GSM or WCDMA.

The serving gateway 164 may be connected to each of the eNode-Bs 160a, 160b, and/or 160c in the RAN 104 via the S1 interface. The serving gateway 164 may generally route and forward user data packets to/from the WTRUs 102a, 102b, and/or 102c. The serving gateway 164 may also perform other functions, such as anchoring user planes during inter-eNode B handovers, triggering paging when downlink data is available for the WTRUs 102a, 102b, and/or 102c, managing and storing contexts of the WTRUs 102a, 102b, and/or 102c, and the like.

The serving gateway 164 may also be connected to the PDN gateway 166, which may provide the WTRUs 102a, 102b, and/or 102c with access to packet-switched networks, such as the Internet 110, to facilitate communications between the WTRUs 102a, 102b, and/or 102c and IP-enabled devices.

The core network 107 may facilitate communications with other networks. For example, the core network 107 may provide the WTRUs 102a, 102b, and/or 102c with access to circuit-switched networks, such as the PSTN 108, to facilitate communications between the WTRUs 102a, 102b, and/or 102c and traditional land-line communications devices. For example, the core network 107 may include, or may communicate with, an IP gateway (e.g., an IP multimedia subsystem (IMS) server) that serves as an interface between the core network 107 and the PSTN 108. In addition, the core network 107 may provide the WTRUs 102a, 102b, and/or 102c with access to the networks 112, which may include other wired or wireless networks that are owned and/or operated by other service providers.

FIG. 11E depicts a system diagram of the RAN 105 and the core network 109 according to an embodiment. The RAN 105 may be an access service network (ASN) that employs IEEE 802.16 radio technology to communicate with the WTRUs 102a, 102b, and/or 102c over the air interface 117. As will be further discussed below, the communication links between the different functional entities of the WTRUs 102a, 102b, and/or 102c, the RAN 105, and the core network 109 may be defined as reference points.

As shown in FIG. 11E, the RAN 105 may include base stations 180a, 180b, and/or 180c, and an ASN gateway 182, though it will be appreciated that the RAN 105 may include any number of base stations and ASN gateways while remaining consistent with an embodiment. The base stations 180a, 180b, and/or 180c may each be associated with a particular cell (not shown) in the RAN 105 and may each include one or more transceivers for communicating with the WTRUs 102a, 102b, and/or 102c over the air interface 117. In one embodiment, the base stations 180a, 180b, and/or 180c may implement MIMO technology. Thus, the base station 180a, for example, may use multiple antennas to transmit wireless signals to, and receive wireless signals from, the WTRU 102a. The base stations 180a, 180b, and/or 180c may also provide mobility management functions, such as handoff triggering, tunnel establishment, radio resource management, traffic classification, quality of service (QoS) policy enforcement, and the like. The ASN gateway 182 may serve as a traffic aggregation point and may be responsible for paging, caching of subscriber profiles, routing to the core network 109, and the like.

The air interface 117 between the WTRUs 102a, 102b, and/or 102c and the RAN 105 may be defined as an R1 reference point that implements the IEEE 802.16 specification. In addition, each of the WTRUs 102a, 102b, and/or 102c may establish a logical interface (not shown) with the core network 109. The logical interface between the WTRUs 102a, 102b, and/or 102c and the core network 109 may be defined as an R2 reference point, which may be used for authentication, authorization, IP host configuration management, and/or mobility management.

The communication link between each of the base stations 180a, 180b, and/or 180c may be defined as an R8 reference point that includes protocols for facilitating WTRU handovers and the transfer of data between base stations. The communication link between the base stations 180a, 180b, and/or 180c and the ASN gateway 182 may be defined as an R6 reference point. The R6 reference point may include protocols for facilitating mobility management based on mobility events associated with each of the WTRUs 102a, 102b, and/or 102c.

As shown in FIG. 11E, the RAN 105 may be connected to the core network 109. The communication link between the RAN 105 and the core network 109 may defined as an R3 reference point that includes protocols for facilitating data transfer and mobility management capabilities, for example. The core network 109 may include a mobile IP home agent (MIP-HA) 184, an authentication, authorization, accounting (AAA) server 186, and a gateway 188. While each of the foregoing elements are depicted as part of the core network 109, it will be appreciated that any one of these elements may be owned and/or operated by an entity other than the core network operator.

The MIP-HA may be responsible for IP address management, and may enable the WTRUs 102a, 102b, and/or 102c to roam between different ASNs and/or different core networks. The MIP-HA 184 may provide the WTRUs 102a, 102b, and/or 102c with access to packet-switched networks, such as the Internet 110, to facilitate communications between the WTRUs 102a, 102b, and/or 102c and IP-enabled devices. The AAA server 186 may be responsible for user authentication and for supporting user services. The gateway 188 may facilitate interworking with other networks. For example, the gateway 188 may provide the WTRUs 102a, 102b, and/or 102c with access to circuit-switched networks, such as the PSTN 108, to facilitate communications between the WTRUs 102a, 102b, and/or 102c and traditional land-line communications devices. In addition, the gateway 188 may provide the WTRUs 102a, 102b, and/or 102c with access to the networks 112, which may include other wired or wireless networks that are owned and/or operated by other service providers.

Although not shown in FIG. 11E, it should, may, and/or will be appreciated that the RAN 105 may be connected to other ASNs and the core network 109 may be connected to other core networks. The communication link between the RAN 105 the other ASNs may be defined as an R4 reference point, which may include protocols for coordinating the mobility of the WTRUs 102a, 102b, and/or 102c between the RAN 105 and the other ASNs. The communication link between the core network 109 and the other core networks may be defined as an R5 reference, which may include protocols for facilitating interworking between home core networks and visited core networks.

Although the terms device, UE, or WTRU may be used herein, it may and should be understood that the use of such terms may be used interchangeably and, as such, may not be distinguishable.

Further, although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

1-34. (canceled)

35. A method of using a device management agent (DMAG) to recover a device, the method comprising:
interfacing with a hypervisor to provide security to the DMAG;
receiving an indication that at least one of an application or an operating system on the device is not in normal service;
receiving control of the device upon determining the device is not in the normal service;
initiating a secure session with a Device Management Server (DMS) based on at least one of the application or operating system not being in the normal service; receiving an indication from the DMS that the device has a software problem;
receiving instructions from the DMS to initiate a recover or upgrade session based on the device having the software problem; and
performing a re-flash of a software image of at least one the operating system or the application based on the device having the potential software problem based on instructions from the DMS.

36. The method of claim 35, further comprising executing a re-boot request command, based on instructions from the DMS, such that the device is re-booted in response to the recover or upgrade session and the re-flash.

37. The method of claim 35, further comprising checking an integrity of the hypervisor on the device.

38. The method of claim 37, wherein the integrity is checked after the recovery or upgrade session and re-flash.

39. The method of claim 35, further comprising, the DMAG, receiving a set of diagnostic commands from the DMS to determine whether the application and/or operating system is in the normal service.

40. The method of claim 35, further comprising:
receiving, at the DMAG, a failure notification indicating that the application and/or operating system is not in the normal service; and
registering and/or storing the failure notification with the DMS.

41. The method of claim 35, wherein the DMAG receives control of the device in response to a time out or expiration of a WatchDog timer.

42. The method of claim 35, wherein the DMAG receives control of the device via a handover by the device and/or the hypervisor.

43. The method of claim 42, wherein the DMAG receives the handover from a WatchDog timer reset.

44. The method of claim 43, wherein the DMAG determines that the application and/or the operating system on the device is not in the normal service based on the handover occurring from the WatchDog timer reset.

45. A device for performing a device recovery using a device management agent (DMAG), comprising:
a DMAG processor configured to:
interface with a hypervisor to provide security to the DMAG;
receive an indication that at least one of an application or an operating system on the device is not in normal service;
receive control of the device upon determining the device is not in the normal service;
initiate a secure session with a Device Management Server (DMS) based on at least one of the application or operating system not being in the normal service;
receive an indication from the DMS that the device has a software problem;
receive instructions from the DMS to initiate a recover or upgrade session based on the device having the software problem; and
perform a re-flash of a software image of at least one the operating system or the application based on the device having the potential software problem based on instructions from the DMS.

46. The device of claim 45, wherein the device DMAG processor is further configured to execute a re-boot request command, based on instructions from the DMS, such that the device is re-booted in response to the recover or upgrade session and the re-flash.

47. The device of claim 45, wherein the device DMAG processor is further configured to check an integrity of the hypervisor on the device.

48. The device of claim 47, wherein the DMAG processor is further configured to check the integrity after the recovery or upgrade session and re-flash.

49. The device of claim 45, wherein the device DMAG processor is further configured to receive a set of diagnostic commands from the DMS to determine whether the application and/or operating system is in the normal service.

50. The device of claim 45, wherein the device DMAG processor is further configured to:
receive a failure notification indicating that the application and/or operating system is not in the normal service; and
register and store the failure notification with the DMS.

51. The device of claim 45, wherein the DMAG processor is further configured to receive control of the device in response to a time out or expiration of a WatchDog timer.

52. The device of claim 45, wherein DMAG processor is further configured to receive the control of the device via a handover by the device and/or the hypervisor.

53. The device of claim 52, wherein the DMAG processor is further configured to receive the handover from a WatchDog timer reset.

54. The device of claim 53, wherein the DMAG processor is further configured to determine that the application and/or the operating system on the device is not in the normal service based on the handover occurring from the WatchDog timer reset.
